(19) United States
(12) Patent Application Publication
(10) Pub. No.: US 2022/0297902 A1
(43) Pub. Date: Sep. 22, 2022

(54) Mir top

(71) Applicant: DARRIEN ALLEN, Highland Park, MI (US)

(72) Inventor: DARRIEN ALLEN, Highland Park, MI (US)

(21) Appl. No.: 17/300,134

(22) Filed: Mar. 22, 2021

(51) Int. Cl. B65D 47/24; A23L 33/105; A23P 20/10; A23L 2/56

(52) U.S. Cl. CPC B65D 47/243; A23L 33/105; A23P 20/10; A23L 2/56; A23V 2002/00

(57) ABSTRACT

A push-pull drinking top including a Synespalum Dulcificum coating around the spout of the push-pull top. The purpose for this top is to alter the taste of sour or bitter bottled drinks, altering the sour or bitter taste into a sweet taste, without adding extra sugars or sweetness. Also giving the user the ability to lower the sugar consumption in all drinks without losing its sweet taste and giving the user a healthier drink to consume.

### FIELD OF INVENTION

The present invention relates to a “drinking cap”

### BACKGROUND

Regular “push-pull” drinking caps allow a user to grab with one's teeth or hands, and pull out to allow water flow, then push back in to stop water flow, but regular push pull caps do not contain or distribute a substance that will alter the user's taste buds. User's taste buds will be altered by changing the taste of sour or bitter beverages and foods, into sweet tasting Beverages and foods.

Presently there is no solution for a Drinking Cap that contains and distributes a substance that alters the user's taste buds, by changing Beverages and Foods that are sour or bitter, into a sweet tasting Beverage and Food.

### SUMMARY OF INVENTION

The present invention seeks to provide a solution to this problem. By providing a drinking cap that contain and distribute a Fruit called “Synsepalum Dulcificum”. When Synsepalum Dulcifcum coats a user's tongue, it alters the user's taste buds by changing Beverages and Foods that are sour or bitter, into sweet tasting Beverages and Foods.

### BASIC DESCRIPTION OF HOW IT WORKS

The Drinking Cap, also known as a “push-pull cap”. It is coated with a fruit called. “Synsepalum Dulcificum.” Synsepalum Dulcificum can be easily applied if Fruit is Freeze Dried before using. This Fruit can be applied using any sticky agent, preferable “Honey”. Then user places push-pull cap coated with Synsepalum Dulcificum Fruit substance into the user's mouth. Before the user Eats the Synsepalum Dulcificum Fruit substance from cap. User MUST allow the Fruit substance to coat user's tongue. After the user's tongue is coated. The user's taste buds will be altered for a period of time. User's taste buds will be altered by changing sour and bitter Beverages and Foods, into sweet tasting Beverages and Foods.

Preferably the drinking cap, also known as a “push-pull cap” has a synsepalum dulcificum coating around the head of cap. This substance can be coated using any sticky agent, preferably “Honey”. Synsepalum Dulcifium is a natural Fruit. This Fruit contains an agent called “Miraculin”. Miraculin is the active agent in Synsepalum Dulcificum that will alter a user's taste buds, by changing Beverages and Foods that are sour or bitter, into sweet tasting Beverages and Foods.

### DESCRIPTION OF DRAWINGS

FIG. 1. Displays a drawing of a “Synseplaum Dulcificum Fruit.”

FIG. 2. Displays a drawing of dots representing the Synsepalum Dulcificum Fruit after being freeze dried and crushed.

FIG. 3. Displays a drawing of a “Push-Pull” bottle cap.

FIG. 4. Displays a drawing of a user's mouth with tongue out.

FIG. 5. Displays a drawing of a user's tongue.

FIG. 6. Displays a drawing of a push-pull cap after it has been coated with Synsepalum Dulcificum.

FIG. 7. Displays a drawing of the user's tongue after it has been coated with Synsepalum Dulcificum. The dots represent the fruit after being freeze dried and crushed.

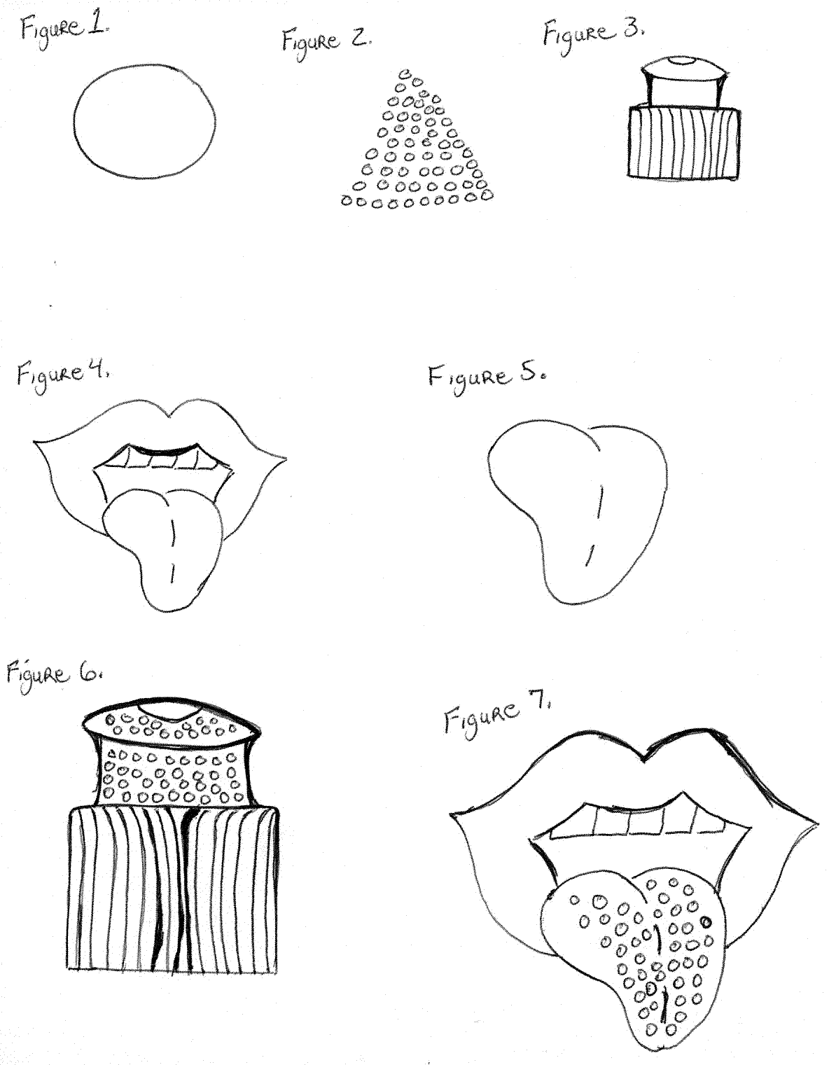

The claimed invention is:

1. A push-pull drinking top comprising a Synespalum Dulcificum coating around the spout of the push-pull top.
